(19) United States
(12) Patent Application Publication
(10) Pub. No.: US 2024/0158027 A1
(43) Pub. Date: May 16, 2024

(54) WHEEL ASSEMBLY, TRACK SYSTEM, AND LIGHT-HEAVY DUTY VEHICLE

(71) Applicant: SOUCY INTERNATIONAL INC., Drummondville (CA)

(72) Inventors: Gabriel LANDRY, Saint-Mathieu-de-Laprairie (CA); Yves SAUVAGEAU, Drummondville (CA); Gregory WRIGHT, Inverness (CA); Branislav NANAC, Drummondville (CA)

(21) Appl. No.: 18/507,671

(22) Filed: Nov. 13, 2023

Related U.S. Application Data
(60) Provisional application No. 63/425,095, filed on Nov. 14, 2022.

(51) Int. Cl. B62D 55/14; B62D 55/24

(52) U.S. Cl. CPC B62D 55/14; B62D 55/242

(57) ABSTRACT

A wheel assembly, track system and light heavy-duty vehicle are disclosed. The wheel assembly has a wheel and an axle defining a shoulder member and a retaining zone. The wheel assembly also has a first bearing assembly disposed inwardly from the shoulder member and a second bearing assembly disposed inwardly from the retaining zone. The wheel assembly also has a sleeve member disposed between the first bearing assembly and the second bearing assembly, and a retaining member cooperating with the retaining zone such that the first and second bearing assemblies are prevented from axial movement by the shoulder member, the sleeve member, and the retaining member.

### CROSS-REFERENCE TO RELATED APPLICATIONS

This application claims the benefit of and priority to U.S. provisional patent application No. 63/425,095, filed on Nov. 14, 2022; the content of all of which is herein incorporated in entirety by reference.

### TECHNICAL FIELD

The present technology relates to wheel assemblies for track systems, wheel assemblies for track systems of light-heavy duty vehicles, track systems for light heavy-duty vehicles, and light-heavy duty vehicles having the track systems and the wheel assemblies.

### BACKGROUND

Certain vehicles, such as, for example, agricultural vehicles (e.g., harvesters, combines, tractors, etc.) and construction vehicles (e.g., bulldozers, front-end loaders, etc.) are used on ground surfaces that are soft, slippery and/or uneven (e.g., soil, mud, sand, ice, snow, etc.).

Conventionally, such vehicles have had large wheels with tires on them to move the vehicle along the ground surface. Under certain conditions, such tires may have poor traction on some kinds of ground surfaces, and as these vehicles are generally heavy, the tires may compact the ground surface in an undesirable way owing to the weight of the vehicle.

In order to reduce the aforementioned drawbacks, to increase traction and to distribute the weight of the vehicle over a larger area on the ground surface, track systems were developed to be used in place of at least some of the wheels and tires on the vehicles. For example, under certain conditions, track systems enable construction vehicles to be used in wet field conditions as opposed to its wheeled counterpart.

Conventional track systems, especially those used with light and medium duty vehicles, do, however, present some inconveniences. Such vehicles are typically equipped with track systems having a metallic track made of linked metallic segments or an elastomeric track with embedded reinforcing members typically made of steel. Such tracks can have low operational top speeds, can be noisy, can have high vibration and can have a low ride quality.

In addition, conventional track systems are equipped with track wheels that are connected to axles by bushings. This can also contribute to low operational speeds, can be noisy, can have high vibration and can have a low ride quality.

Therefore, there is a desire for a track system and wheel assemblies that could mitigate at least some of the above-mentioned issues.

### SUMMARY

It is therefore an object of the present technology to ameliorate the situation with respect to at least one of the inconveniences present in the prior art. It is also an object of the present technology to provide an improved track system and support wheel assemblies at least in some instances as compared with some of the prior art.

In the context of the following description, “outwardly” or “outward” means away from a longitudinal center plane of the track system, and “inwardly” or “inward” means toward the longitudinal center plane. In addition, in the context of the following description, “longitudinally” means in a direction parallel to the longitudinal center plane of the track system in a plane parallel to flat level ground, “laterally” means in a direction perpendicular to the longitudinal center plane in a plane parallel to flat level ground, and “generally vertically” means in a direction contained in the longitudinal center plane along a height direction of the track system generally perpendicular to flat level ground. Also, the term “wheel assemblies” include all the necessary structure (bearing structures, pins, axles and other components) to permit a structure/wheel to pivot/rotate about an axis, as the case may be.

In a first broad aspect of the present technology, there is provided a wheel assembly for a track system of a light heavy-duty vehicle, the track system having a frame and an elastomeric endless track, the wheel assembly being removably connectable to the frame. The wheel assembly comprises a wheel defining a wheel cavity. The wheel assembly comprises an axle receivable in the wheel cavity and including a first end portion, a middle portion, and a second end portion. The axle defines a shoulder member proximate to the first end portion and a retaining zone proximate to the second end portion. The wheel assembly comprises a first bearing assembly and a second bearing assembly. The first and second bearing assemblies are rotationally connecting the axle to the wheel. The first bearing assembly is disposed in the wheel cavity proximate to the first end portion and inwardly from the shoulder member. The second bearing assembly is disposed in the wheel cavity proximate to the second end portion and inwardly from the retaining zone. The wheel assembly comprises a sleeve member being disposed on the middle portion and between the first bearing assembly and the second bearing assembly. The wheel assembly comprises a retaining member cooperating with the retaining zone such that the first and second bearing assemblies are prevented from axial movement by the shoulder member, the sleeve member, and the retaining member.

In some embodiments of the wheel assembly, the wheel has a first side and a second side opposite to the first side, and a portion of the first end portion of the axle extends from the first side of the wheel and a portion of the second end portion of the axle extends from the second side of the wheel.

In some embodiments of the wheel assembly, the wheel assembly further comprises a first seal disposed in the wheel cavity, outwardly to the first bearing assembly and in contact with the wheel and the axle, the first seal sealing one side of the wheel cavity; and a second seal disposed in the wheel cavity, outwardly to the second bearing assembly and in contact with the wheel and the axle, the second seal sealing another side of the wheel cavity.

In some embodiments of the wheel assembly, the first bearing assembly includes a first seal integrated to the first bearing assembly and the second bearing assembly includes a second seal integrated to the second bearing assembly.

In some embodiments of the wheel assembly, the wheel assembly further comprises a first fastener connectable to the first end portion of the axle and a second fastener connectable to the second end portion of the axle, the first and second fasteners removably connecting the wheel assembly to the frame of the track system.

In some embodiments of the wheel assembly, the first and second bearing assemblies are connected to the axle by one of an interference fit, a clearance fit, and a transition fit.

In some embodiments of the wheel assembly, the retaining member is a nut and the retraining zone is a threaded zone configured to cooperate with the nut.

In some embodiments of the wheel assembly, the wheel cavity has an inner cylindrical wall and the first and second bearing assemblies are connected to the inner cylindrical wall by one of an interference fit, a clearance fit, and a transition fit.

In some embodiments of the wheel assembly, at least one of the first and the second bearing assemblies includes a spherical bearing.

In some embodiments of the wheel assembly, at least one of the first and the second bearing assemblies includes a spherical roller bearing.

In some embodiments of the wheel assembly, at least one of the first and the second bearing assemblies includes a tapered roller bearing.

In some embodiments of the wheel assembly, the wheel has a first track-engaging portion, a second track-engaging portion, and a central portion defined between the first and second track engaging portions.

In some embodiments of the wheel assembly, the elastomeric track is a polymeric elastomeric track.

In some embodiments of the wheel assembly, the elastomeric track is laterally deformable.

In some embodiments of the wheel assembly, the elastomeric track is laterally deformable along an entire width of the elastomeric track.

In some embodiments of the wheel assembly, the elastomeric track is longitudinally reinforced.

In some embodiments of the wheel assembly, the elastomeric track is longitudinally reinforced with longitudinal reinforcing members.

In some embodiments of the wheel assembly, the longitudinally reinforced elastomeric track is non-reinforced laterally.

In some embodiments of the wheel assembly, the light heavy-duty vehicle is one of a compact track loader and tracked skid-steer.

In some embodiments of the wheel assembly, the wheel assembly is at least one of a support wheel assembly and an idler wheel assembly.

In a second broad aspect of the present technology, there is provided a track system operatively connectable to a light heavy-duty vehicle. The track system comprises a frame; a sprocket wheel assembly rotationally connected to the frame; and at least one wheel assembly removably and rotationally connected to the frame. The wheel assembly comprises a wheel defining a wheel cavity. The wheel assembly comprises an axle receivable in the wheel cavity and including a first end portion, a middle portion, and a second end portion. The axle defines a shoulder member proximate to the first end portion and a retaining zone proximate to the second end portion. The wheel assembly comprises a first bearing assembly and a second bearing assembly. The first and second bearing assemblies are rotationally connecting the axle to the wheel. The first bearing assembly is disposed in the wheel cavity proximate to the first end portion and inwardly from the shoulder member and the second bearing assembly is disposed in the wheel cavity proximate to the second end portion and inwardly from the retaining zone. The wheel assembly comprises a sleeve member being disposed on the middle portion and between the first bearing assembly and the second bearing assembly. The wheel assembly comprises a retaining member cooperating with the retaining zone such that the first and second bearing assemblies are prevented from axial movement by the shoulder member, the sleeve member, and the retaining member. The track system comprises an elastomeric endless track surrounding the frame, the sprocket wheel assembly, and the at least one wheel assembly.

In some embodiments of the track system, the wheel has a first side and a second side opposite to the first side, and a portion of the first end portion of the axle extends from the first side of the wheel and a portion of the second end portion of the axle extends from the second side of the wheel.

In some embodiments of the track system, the at least one wheel assembly further comprises: a first seal disposed in the wheel cavity, outwardly to the first bearing assembly and in contact with the wheel and the axle, the first seal sealing one side of the wheel cavity; and a second seal disposed in the wheel cavity, outwardly to the second bearing assembly and in contact with the wheel and the axle, the second seal sealing another side of the wheel cavity.

In some embodiments of the track system, the first bearing assembly includes a first seal integrated to the first bearing assembly and the second bearing assembly includes a second seal integrated to the second bearing assembly.

In some embodiments of the track system, the at least one wheel assembly further comprises a first fastener connectable to the first end portion of the axle and a second fastener connectable to the second end portion of the axle, the first and second fasteners removably connecting the wheel assembly to the frame of the track system.

In some embodiments of the track system, the first and second bearing assemblies are connected to the axle by one of an interference fit, a clearance fit, and a transition fit.

In some embodiments of the track system, the retaining member is a nut and the retraining zone is a threaded zone configured to cooperate with the nut.

In some embodiments of the track system, the wheel cavity has an inner cylindrical wall and the first and second bearing assemblies are connected to the inner cylindrical wall by one of an interference fit, a clearance fit, and a transition fit.

In some embodiments of the track system, at least one of the first and the second bearing assemblies includes a spherical bearing.

In some embodiments of the track system, at least one of the first and the second bearing assemblies includes a spherical roller bearing.

In some embodiments of the track system, at least one of the first and the second bearing assemblies includes a tapered roller bearing.

In some embodiments of the track system, the wheel has a first track-engaging portion, a second track-engaging portion, and a central portion defined between the first and second track engaging portions.

In some embodiments of the track system, the elastomeric track is a polymeric track.

In some embodiments of the track system, the elastomeric track is laterally deformable.

In some embodiments of the track system, the elastomeric track is laterally deformable along an entire width of the elastomeric track.

In some embodiments of the track system, the elastomeric track is longitudinally reinforced.

In some embodiments of the track system, the elastomeric track is longitudinally reinforced with longitudinal reinforcing members.

In some embodiments of the track system, the longitudinally reinforced elastomeric track is non-reinforced laterally.

In some embodiments of the track system, the at least wheel assembly is an idler wheel assembly.

In some embodiments of the track system, the at least one wheel assembly is a support wheel assembly.

In a third broad aspect of the present technology, there is provided a light heavy-duty vehicle comprising at least two vehicle axles; at least two track systems, each one of the at least two track systems being operatively connected to one of the at least two vehicle axles. Each of the at least two track systems includes a frame; a sprocket wheel assembly rotationally connected to the frame; and at least one wheel assembly removably and rotationally connected to the frame. The at least one wheel assembly having a wheel defining a wheel cavity. The at least one wheel assembly has an axle receivable in the wheel cavity and including a first end portion, a middle portion, and a second end portion, the axle defining a shoulder member proximate to the first end portion and a retaining zone proximate to the second end portion. The at least one wheel assembly has a first bearing assembly and a second bearing assembly, the first and second bearing assemblies rotationally connecting the axle to the wheel. The first bearing assembly is disposed in the wheel cavity proximate to the first end portion and inwardly from the shoulder member. The second bearing assembly is disposed in the wheel cavity proximate to the second end portion and inwardly from the retaining zone. The at least one wheel assembly has a sleeve member being disposed on the middle portion and between the first bearing assembly and the second bearing assembly. The at least one wheel assembly has a retaining member cooperating with the retaining zone such that the first and second bearing assemblies are prevented from axial movement by the shoulder member, the sleeve member, and the retaining member. Each of the track systems including an elastomeric endless track surrounding the frame, the sprocket wheel assembly, and the at least one wheel assembly.

In some embodiments of the light heavy-duty vehicle, the wheel has a first side and a second side opposite to the first side, and a portion of the first end portion of the axle extends from the first side of the wheel and a portion of the second end portion of the axle extends from the second side of the wheel.

In some embodiments of the light heavy-duty vehicle, the at least one wheel assembly further comprises: a first seal disposed in the wheel cavity, outwardly to the first bearing assembly and in contact with the wheel and the axle, the first seal sealing one side of the wheel cavity; and a second seal disposed in the wheel cavity, outwardly to the second bearing assembly and in contact with the wheel and the axle, the second seal sealing another side of the wheel cavity.

In some embodiments of the light heavy-duty vehicle, the first bearing assembly includes a first seal integrated to the first bearing assembly and the second bearing assembly includes a second seal integrated to the second bearing assembly.

In some embodiments of the light heavy-duty vehicle, the at least one support wheel assembly further comprises a first fastener connectable to the first end portion of the axle and a second fastener connectable to the second end portion of the axle, the first and second fasteners removably connecting the wheel assembly to the frame of the track system.

In some embodiments of the light heavy-duty vehicle, the first and second bearing assemblies are connected to the axle by one of an interference fit, a clearance fit, and a transition fit.

In some embodiments of the light heavy-duty vehicle, the retaining member is a nut and the retraining zone is a threaded zone configured to cooperate with the nut.

In some embodiments of the light heavy-duty vehicle, the wheel cavity has an inner cylindrical wall and the first and second bearing assemblies are connected to the inner cylindrical wall by one of an interference fit, a clearance fit, and a transition fit.

In some embodiments of the light heavy-duty vehicle, at least one of the first and the second bearing assemblies includes a spherical bearing.

In some embodiments of the light heavy-duty vehicle, at least one of the first and the second bearing assemblies includes a spherical roller bearing.

In some embodiments of the light heavy-duty vehicle, at least one of the first and the second bearing assemblies includes a tapered roller bearing.

In some embodiments of the light heavy-duty vehicle, the wheel has a first track-engaging portion, a second track-engaging portion, and a central portion defined between the first and second track engaging portions.

In some embodiments of the light heavy-duty vehicle, the elastomeric track is a polymeric track.

In some embodiments of the light heavy-duty vehicle, the elastomeric track is laterally deformable.

In some embodiments of the light heavy-duty vehicle, the elastomeric track is laterally deformable along an entire width of the elastomeric track.

In some embodiments of the light heavy-duty vehicle, the elastomeric track is longitudinally reinforced.

In some embodiments of the light heavy-duty vehicle, the elastomeric track is longitudinally reinforced with longitudinal reinforcing members.

In some embodiments of the light heavy-duty vehicle, the longitudinally reinforced elastomeric track is non-reinforced laterally.

In some embodiments of the light heavy-duty vehicle, the light heavy-duty vehicle is a compact track loader or a tracked skid-steer.

In some embodiments of the light heavy-duty vehicle, the at least one wheel assembly is a support wheel assembly.

In some embodiments of the light heavy-duty vehicle, the at least one wheel assembly is an idler wheel assembly.

Embodiments of the present technology each have at least one of the above-mentioned objects and/or aspects, but do not necessarily have all of them. It should be understood that some aspects of the present technology that have resulted from attempting to attain the above-mentioned object may not satisfy this object and/or may satisfy other objects not specifically recited herein.

Additional and/or alternative features, aspects, and advantages of embodiments of the present technology will become apparent from the following description, the accompanying drawings, and the appended claims.

### BRIEF DESCRIPTION OF THE DRAWINGS

For a better understanding of the present technology, as well as other aspects and further features thereof, reference is made to the following description which is to be used in conjunction with the accompanying drawings, where:

FIG. 1 is a perspective view taken from a top, front, left side of a compact track loader with track systems according to an embodiment of the present technology;

FIG. 2 is a perspective view taken from a top, front, right side of the track system of the compact track loader of FIG. 1;

FIG. 3 is a right side elevation view of the track system of FIG. 2;

FIG. 4 is a cross-sectional view of the track system of FIG. 2 taken along the lines 4-4 of FIG. 3;

FIG. 5 is a perspective view taken from a top, front, right side of a support wheel assembly of the track system of FIG. 2; and

FIG. 6 is a front cross-sectional view of the support wheel assembly of FIG. 5 taken along the plane 6-6 of FIG. 5.

FIG. 7 is a perspective cross-sectional view taken from a top, front, right side of the support wheel assembly of FIG. 5 taken along the plane 6-6 of FIG. 5.

FIG. 8 is a perspective view taken from a top, front, right side of an idler wheel assembly of the track system of FIG. 2; and

FIG. 9 is a front cross-sectional view of the support wheel assembly of FIG. 8 taken along the plane 9-9 of FIG. 8.

FIG. 10 is a perspective cross-sectional view taken from a top, front, right side of the idler wheel assembly of FIG. 8 taken along the plane 9-9 of FIG. 8.

FIG. 11 depicts a spherical bearing and a spherical roller bearing as contemplated in at least some embodiments of the present technology.

### DETAILED DESCRIPTION

The present detailed description is intended to be a description of illustrative examples of the present technology. This description is not intended to define the scope or set forth the bounds of the present technology. In some cases, what are believed to be helpful examples of modifications or alternatives to apparatus may also be set forth below. This is done merely as an aid to understanding, and, again, not to define the scope or set forth the bounds of the present technology. These modifications are not an exhaustive list, and, as a person skilled in the art would understand, other modifications are likely possible. Further, where this has not been done (i.e., where no examples of modifications have been set forth), it should not be interpreted that no modifications are possible and/or that what is described is the sole manner of implementing or embodying that element of the present technology. As a person skilled in the art would understand, this is likely not the case. In addition, it is to be understood that the apparatus may provide in certain aspects a simple embodiment of the present technology, and that where such is the case it has been presented in this manner as an aid to understanding. As persons skilled in the art would understand, various embodiments of the present technology may be of a greater complexity than what is described herein.

As used herein, the singular form “a,” “an” and “the” include plural referents unless the context clearly dictates otherwise.

The recitation herein of numerical ranges by endpoints is intended to include all numbers subsumed within that range (e.g., a recitation of 1 to 5 includes 1, 1.5, 2, 2.75, 3, 3.80, 4, 4.32, and 5).

The term “about” is used herein explicitly or not, every quantity given herein is meant to refer to the actual given value, and it is also meant to refer to the approximation to such given value that would reasonably be inferred based on the ordinary skill in the art, including equivalents and approximations due to the experimental and/or measurement conditions for such given value. For example, the term “about” in the context of a given value or range refers to a value or range that is within 20%, preferably within 15%, more preferably within 10%, more preferably within 9%, more preferably within 8%, more preferably within 7%, more preferably within 6%, and more preferably within 5% of the given value or range.

The expression “and/or” where used herein is to be taken as specific disclosure of each of the two specified features or components with or without the other. For example, “A and/or B” is to be taken as specific disclosure of each of (i) A, (ii) B and (iii) A and B, just as if each is set out individually herein.

As used herein, the term “comprise” is used in its non-limiting sense to mean that items following the word are included, but items not specifically mentioned are not excluded.

The present technology relates to a wheel assembly, which is removably connectable to a frame of a track system. The track system has a wheel, an axle and bearing assemblies rotationally connecting the axle to the wheel. The wheel assembly will be described with reference to a compact track loader. However, it is contemplated that the wheel assembly could be used with other types of light heavy-duty vehicle such as, but not limited to, tracked skid-steers, and mini excavators.

### Light-Heavy Duty Vehicle

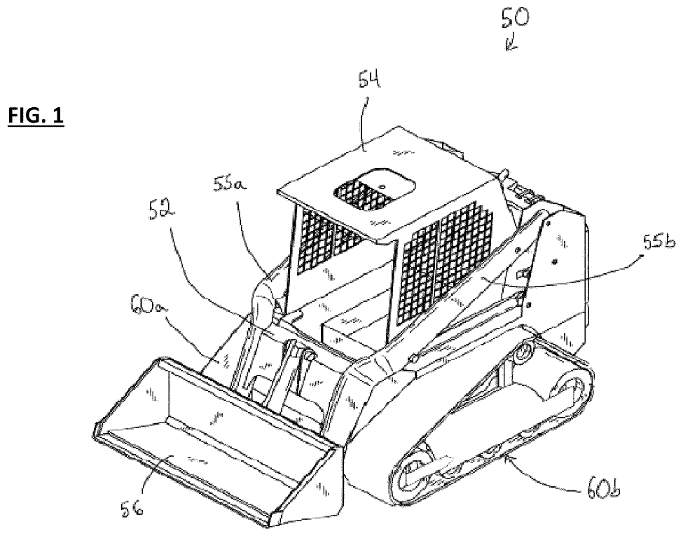

Referring to FIG. 1, an embodiment of the compact track loader 50 will be described. The compact track loader 50 has a body 52. A cab 54 extends upwardly from the body 52. The compact track loader 50 also has loader arms 55a, 55b pivotally and operationally connected to the body 52. A bucket 56 is connected at a front end of the loader arms 55a, 55b. Thus, when the loader arms 55a, 55b are operated, the bucket 56 can be moved. The compact track loader 50 also has a right track system 60a disposed on the right side of the body 52 (only partially shown in FIG. 1), and a left track system 60b disposed on the left side of the body 52. The left and right track systems 60a, 60b are operationally connected to the compact track loader 50. The compact track loader 50 is a light heavy-duty vehicle, such that the compact track loader 50 weighs approximately 10,000 lbs. It is contemplated that in other embodiments, the compact track loader 50 could weight more or less than about 10,000 lbs. For instance, the compact track loader could weight about 8,000 lbs, about 9,000 lbs, about 11,000 lbs or about 12,000 lbs. As mentioned above, it is understood that the compact track loader 50 could be other types of light heavy-duty vehicles.

### Track System

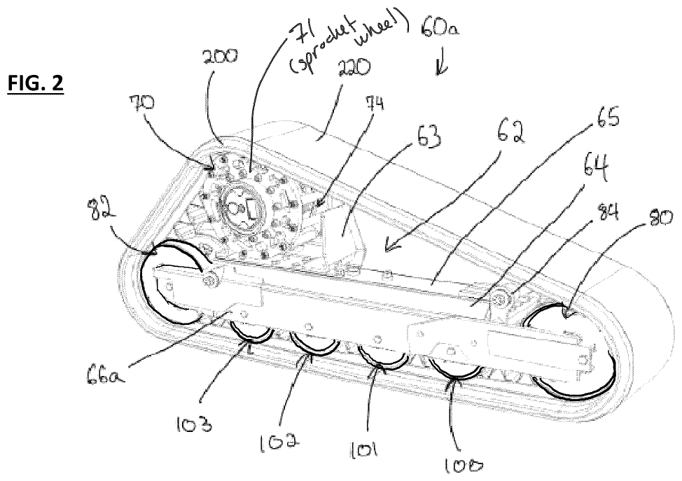

With reference to FIGS. 2 to 4, there is depicted the right track system 60a. It should be noted that the left and right track systems 60a, 60b are generally symmetric and therefore only the right track system 60a will be described in detail for sake of brevity. In some embodiments of the present technology, the light track system 60b may be a mirror image of the right track system 60a.

The track system 60a comprises a frame 62 that has an upper frame section 63 and a lower frame section 64 that generally extends in the longitudinal direction. The lower frame section 64 has a top frame portion 65, a lateral frame portion 66a extending downwardly to the left from the top frame portion 65 and a lateral frame portion 66b extending downwardly to the right from the top frame portion 65.

The track system 60a also comprises a sprocket wheel assembly 70 that is rotationally connected to the frame 62. More precisely, the sprocket wheel assembly 70 is rotationally connected to the upper frame section 63. The sprocket wheel assembly 70 is also operatively connected to a driving axle (not shown) of the compact track loader 50. The sprocket wheel assembly 70 comprises a sprocket wheel 71. The sprocket wheel 71 defines recesses 74 that are longitudinally spaced on a circumference thereof. As it will be described in greater detail below, the recesses 74 are configured to receive lugs 202 of an endless track 200.

The track system 60a comprises a front idler wheel assembly 80 and a rear idler wheel assembly 82, both of which are rotationally connected to the frame 62. More precisely, the front and rear idler wheel assemblies 80, 82 are rotationally and removably connected to the lower frame section 64. It is contemplated that in other embodiments, there could be more or less than two idler wheel assemblies.

In the present embodiment, the front and rear idler wheel assemblies 80, 82 aid in distributing borne load to the ground, and as such act as support wheel assemblies 80, 82. It is contemplated that in some embodiments, the front and rear idler wheel assemblies could not be support wheel assemblies.

The track system 60a also comprises a tensioner 84 operatively connected to the front idler wheel assembly 80. The tensioner 84 is operable to change the tension in the endless track 200 by moving the front idler wheel assembly 80. It is contemplated that in some embodiments, the tensioner 84 could be connected to the rear idler wheel assembly 82. It is also contemplated that in some embodiments, the tensioner 84 could be omitted. The front and rear idler wheel assemblies 80, 82 will be described in greater detail below.

The track system 60a also comprises four support wheel assemblies 100, 101, 102, 103 that are removably connected to the frame 62. More precisely, the four support wheel assemblies 100, 101, 102 103 are removably and rotationally connected to the lower frame section 64. It is contemplated that in some embodiments, there could be more or less than four support wheel assemblies. In the illustrated embodiment, the support wheel assemblies 100, 101, 102, 103 are disposed between the lateral frame portions 66a, 66b. The support wheel assemblies 100, 101, 102, 103 will be described in greater detail below.

The track system 60a also comprises the endless track 200, which surrounds the frame 62, the sprocket wheel assembly 70, the front and rear idler wheel assemblies 80, 82 and the support wheel assemblies 100, 101, 102, 103. The endless track 200 is an elastomeric track. In the present embodiment, the endless track 200 is a polymeric track. The endless track 200 has an inner surface 210 and an outer surface 220.

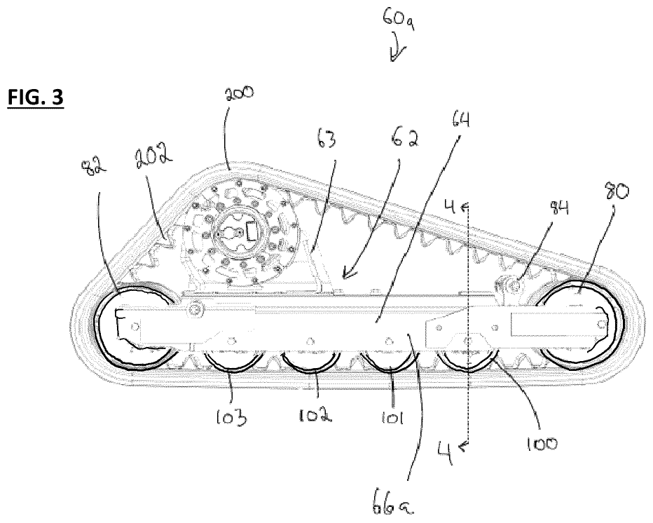

As best seen on FIG. 3, the inner surface 210 of the endless track 200 has a set of lugs 202. The set of lugs 202 is positioned at a central portion of the inner surface 210. The lugs 202, which are longitudinally spaced, are configured to engage with the recesses 74 of the sprocket wheel assembly 70. The outer surface 220 of the endless track 200 has a tread (not shown) defined thereon. It is contemplated that the tread could vary from one embodiment to another. In some embodiments, the tread could depend on the type of ground surface on which the compact track loader 50 is destined to travel.

The endless track 200 is longitudinally reinforced. More precisely, the endless track 200 is longitudinally reinforced with longitudinal reinforcing members 204. The longitudinal reinforcing members 204 are longitudinal cables 204. It is contemplated that the longitudinal reinforcing members 204 could be replaced with other forms of longitudinal reinforcing members without departing from the present technology.

The endless track 200 is laterally deformable. In the present embodiment, the endless track 200 is laterally deformable along an entire width of the endless track 200. Thus, the endless track 200 is non-reinforced laterally. In some embodiments, the endless track 200 could have reinforcing members that span a portion of the width of the endless track 200.

### Support Wheel Assembly

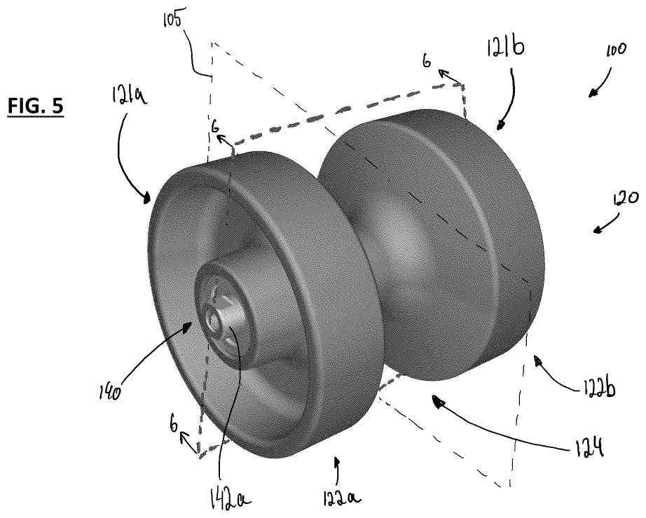

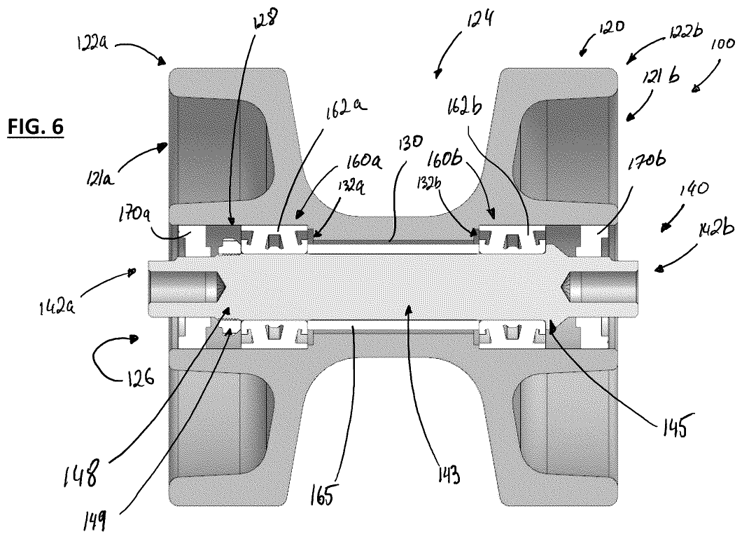

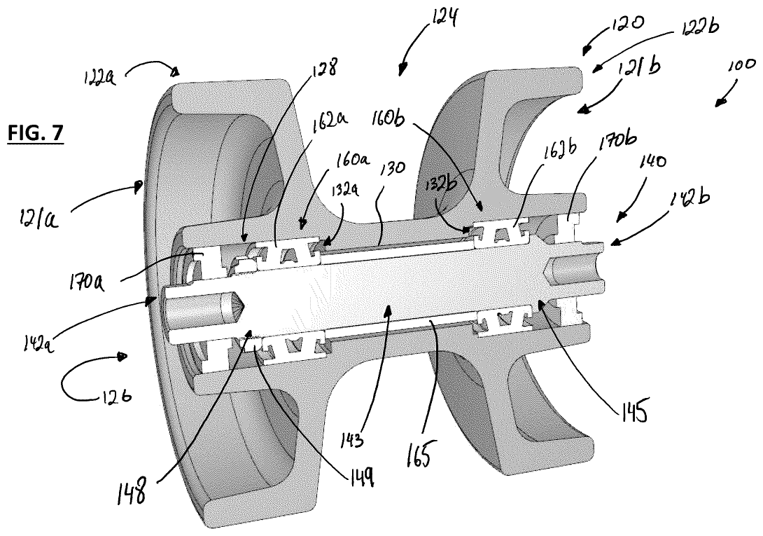

Referring to FIGS. 5 to 7, the support wheel assembly 100 will now be described. As the support wheel assemblies 100, 101, 102, 103 are generally similar, only the support wheel assembly 100 will be described in detail.

The support wheel assembly 100 comprises a wheel 120, an axle 140 and, bearings 160a, 160b, a retaining member 149, a sleeve 165, and seals 170a, 170b. As will become apparent from the description below, the support wheel assembly 100 is not unitary with the frame 62.

The wheel 120, which has a lateral side 121a and a lateral side 121b, has a track-engaging portion 122a proximate to the lateral side 121a and a track-engaging portion 122b proximate to the lateral side 121b. A central portion 124 is defined between the track-engaging portions 122a, 122b. The central portion 124 is configured to receive the lugs 202 thereinbetween, without interference. The track engaging portions 122a, 122b engage the inner surface 210 of the endless track 200. The wheel 120 defines a wheel cavity 126 that extends through an entire width of the wheel 120. It is contemplated that in some embodiments, the wheel cavity 126 could extend along a portion of the width of the wheel 120. Thus, the wheel 120 has an inner wall 128. In the present embodiment, the inner wall 128 is cylindrical. Within the wheel cavity 126, the wheel 120 has a projecting portion 130 that projects radially away the inner wall 128. The projecting portion 130 is centrally disposed within the wheel cavity 126, and has lateral abutting surfaces 132a, 132b.

The axle 140, which is receivable in the wheel cavity 126, has an axle end portion 142a, an axle end portion 142b, and an axle middle portion 143. The axle 140 defines a shoulder member 145 proximate to the axle end portion 142b and a retaining zone 148 proximate to the axle end portion 142a. The shoulder member 145 and the retaining zone 148 are located on opposite ends of the axle middle portion 143. The retaining zone 148 is configured to retain the retaining member 149 in a pre-determined position along the axle 140. In this embodiment, the retaining zone 148 is embodied as a threaded zone along the axle 140 and the retaining member 149 is embodied as a nut configured to threadedly engage with the axle 140 at the threaded zone.

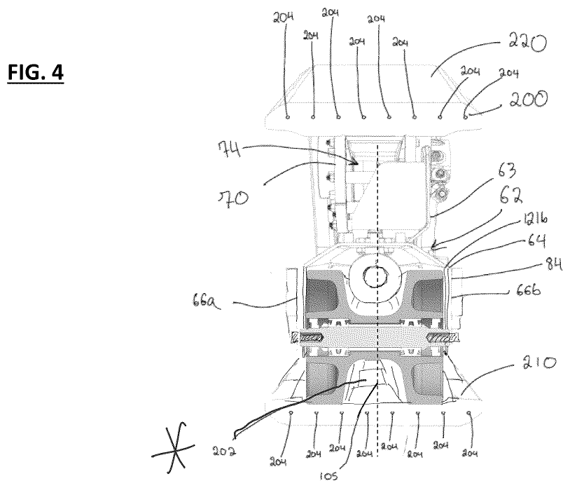

The axle 140 is removably connected to the frame 62. The axle end portion 142a is connectable to the lateral frame portion 66a (see FIG. 4) by a fastener of the wheel assembly 100, and the axle end portion 142b is connectable to the lateral frame portion 66b by a fastener of the wheel assembly 100. The axle 140 is sized to be contained within the frame 62, and extends from the lateral frame portion 66a to the lateral frame portion 66b. Thus, when the axle 140 is received in the wheel cavity 126, a portion of the axle end portion 142a protrudes from the wheel cavity 126 past the lateral side 121a, and a portion of the axle end portion 142b protrudes from the wheel cavity 126 past the lateral side 121b. The axle 140 is configured such that when the axle 140 is received in the wheel cavity 126, the axle 140 does not contact the inner wall 128 or the projecting portion 130.

The axle 140 is rotationally connected to the wheel 120 by the bearing assemblies 160a, 160b. The bearing assemblies 160a, 160b are disposed in the wheel cavity 126. The bearing assembly 160a is disposed at the axle end portion 142a and abuts the lateral abutting surface 132a, and the bearing assembly 160b is disposed at the axle end portion 142b and abuts the lateral abutting surface 132b. As will be described in greater detail below, the bearing assemblies 160a, 160b abutting the lateral abutting surfaces 132a, 132b aid in positioning the bearing assemblies 160a, 160b in the wheel cavity 126. The bearing assemblies 160a, 160b are connected to the axle 140 by a sliding fit, and are connected to the inner wall 128 by an interference fit. In some embodiments, the bearing assemblies 160a, 160b could be connected to the axle 120 and/or to the inner wall 128 by clearance fits (i.e., sliding fits), interference fits (i.e., press fit) and/or transition fit (i.e., similar fit). Thus, the wheel 120 is free to rotate relative to the axle 140 due to the bearing assemblies 160a, 160b. The bearing assemblies 160a, 160b can sustain relatively high radial loads. In this embodiment, the bearing assembly 160a includes a tapered roller bearing 162a, and the bearing assembly 160b includes a tapered roller bearing 162b. It is contemplated that in some embodiments, other types of bearings could be used such as needle bearings or ball bearings. In some embodiments, the bearing assemblies 160a,160b could include unit bearings.

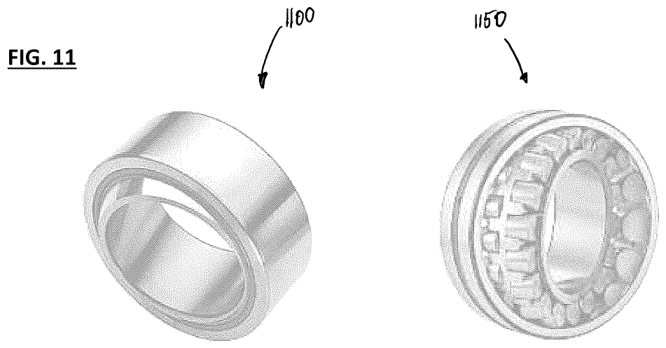

With a brief reference to FIG. 11, there is depicted a spherical bearing 1100 and a spherical roller bearing 1150. It is contemplated that at least one of the bearing assemblies 160a and 160b may include the spherical bearing 1100 and/or a spherical roller bearing 1150, without departing from the scope of the present technology. Developers of the present technology have realized that using spherical bearings and/or spherical roller bearings as part of a given wheel assembly may allow to better distribute axial and/or pivotal load applied onto the axle 140 during operation of the wheel assembly 100.

The wheel assembly 100 also includes the sleeve 165 that is fitted over and/or enclosed the axle middle portion 143. The sleeve 165 abuts the bearing assemblies 160a and 160b and respective sides thereof. As it will be described in greater details herein further below, the sleeve 165 cooperates with the retaining member 149 and the shoulder member 145 for preventing axial movement of the bearing assemblies 160a and 160b and/or pivotal movement of the axle 140 relative to the wheel 120 during operation of the wheel assembly 100. It should be noted that a first side of the sleeve 165 can be in contact with a laterally inward portion of the bearing assembly 160a, and the retaining member 149 can be in contact with a laterally outward portion of the bearing assembly 160a, while a second side of the sleeve 165 can be in contact with a laterally inward portion of the bearing assembly 160b and the shoulder member 145 can be in contact with a laterally outward portion of the bearing assembly 160b.

In some embodiments, it can be said that the shoulder member 145, the bearing assembly 160b, the sleeve 165, the bearing assembly 160a, and the retaining member 149 are disposed in a stacked configuration along the axle 140 to prevent axial movement of the bearing assemblies 160a and 160b and/or pivotal movement of the axle 140 relative to the wheel 120 during operation of the wheel assembly 100.

The wheel assembly 100 also includes the seals 170a, 170b. The seal 170a is disposed in the wheel cavity 126, laterally outwardly to the bearing assembly 160a with reference to the longitudinal wheel assembly center plane 105. The seal 170a has a radial inner surface in contact with axle 140 at the axle end portion 142a and a radial outer surface in contact with the inner wall 128. The seal 170a seals one side of the wheel cavity 126. Similarly, the seal 170b is disposed in the wheel cavity 126, laterally outwardly to the bearing assembly 160b with reference to the longitudinal wheel assembly center plane 105. The seal 170b has a radial inner surface in contact with axle 140 at the axle end portion 142b and a radial outer surface in contact with the inner wall 128. The seal 170b seals the other side of the wheel cavity 126. The seals 170a, 170b can prevent dust or dirt from getting into the bearing assemblies 160a, 160b, thereby protecting the bearings assemblies 160a, 160b. It is contemplated that in some embodiments, the seals 170a, 170b could be omitted. It is contemplated that in some embodiments, the seal 170a could be integrated to the bearing assembly 160a and the seal 170b could be integrated to the bearing assembly 160b to prevent dust and debris from entering the bearing assemblies 160a, 160b. In some embodiments, the seals 170a, 170b are integrated to the bearing assemblies 160a, 160b such that the bearing assemblies 160a, 160b each have two seals disposed on either side of rolling elements, thereby sealing the bearing assemblies 160a, 160b.

### Idler Wheel Assembly

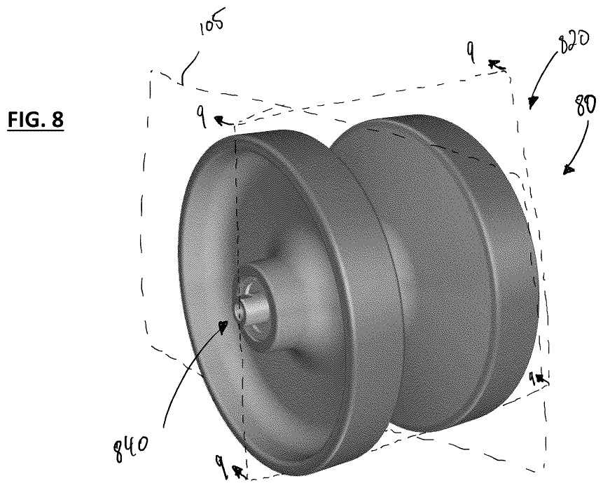

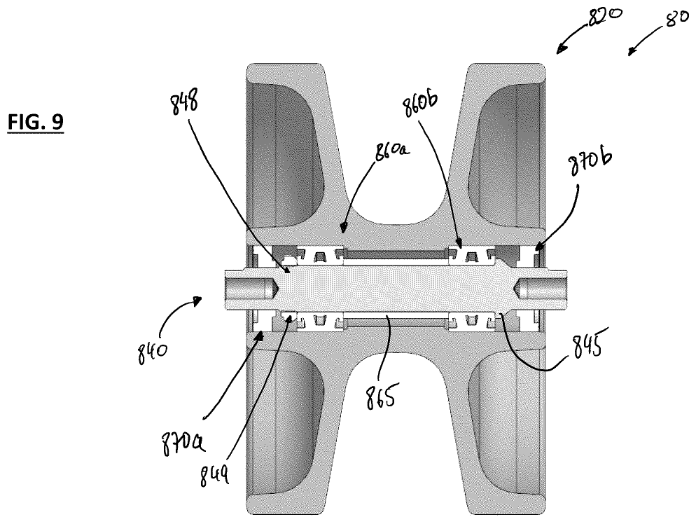

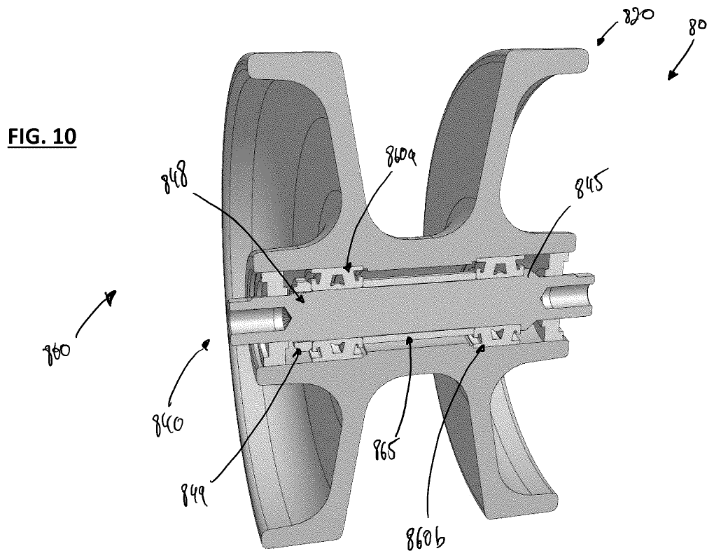

Referring to FIGS. 8 to 10, the front and rear idler wheel assemblies 80, 82 will now be described. As the front and rear idler wheel assemblies 80, 82 are generally similar, only the front idler wheel assembly 80 will be described in detail.

Similar to the support wheel 100, the idler wheel assembly 80 comprises a wheel 820, an axle 840 and, bearings 860a, 860b, a retaining member 849, a sleeve 865 and seals 870a, 870b. It is contemplated that components of the idler wheel assembly 80 may be configured in a similar manner to corresponding components of the support wheel assembly 100. For sake of brevity, the components of the idler wheel assembly 80 will not be described at length. Suffice it to say that the components of the idler wheel assembly 80 may have different shapes and sizes than the corresponding components of the support wheel assembly 100. For example, a diameter of the wheel 820 may be larger than a diameter of the wheel 130.

### Method of Assembly

A method of assembling the support wheel assembly 100 and connecting and removing the support wheel assembly 100 to and from the frame 62 will now be described. It should be noted that assembly of the idler wheel 80 may be implemented in a similar manner to how the assembly of the support wheel 100 is implemented.

First, the support wheel assembly 100 is assembled.

The bearing assembly 160b is fitted over the axle 140 and abuts the shoulder member 145. The sleeve 165 is fitted over the axle middle portion 145. The axle end portion 142a is inserted in the wheel cavity 126. The bearing assembly 160a is fitted over the axle 130 and abuts the shoulder member 145. The retaining member 149 is then engaged with the retaining zone 148. In this embodiment, the nut is threadedly moved along the threaded zone so as to abut the bearing assembly 160a. When the retaining member 149 abuts the bearing assembly 160a, the bearing assembly 160 abuts against the sleeve 165, which in turn abuts against the bearing assembly 162b, which in turn abuts the shoulder member 145. It should be noted that the bearing assemblies 160a, 160b respectively abut the lateral abutting surfaces 132a, 132b. Then, the seals 170a, 170b are inserted in the wheel cavity such that the seals 170a, 170b seal the wheel cavity 126. It is understood that the order of the assembly could change.

It should be noted that when the retaining member 149 is moved along the retaining zone 148, a desired axial load may be applied onto the stacked configuration of the bearing assemblies 160a,160b and the sleeve 165, for preventing axial movement of the bearing assemblies 160a and 160b and/or pivotal movement of the axle 140 relative to the wheel 120. Developers of the present technology have realized that having such an adjustable retaining assembly (e.g., the retaining member 149 is movable/adjustable along the retaining zone 148) may allow compensating for manufacturing defects and/or inaccuracies of at least some components of the wheel assembly 100. Developers of the present technology have also realized that having such an adjustable retaining assembly may also allow to compensate for wear of at least some components of the wheel assembly 100. For example, an operator may apply, and/or re-apply a desired axial load onto the stacked configuration of the bearing assemblies 160a,160b and the sleeve 165 at different instances during the lifespan of the wheel assembly 100.

For example, in this embodiment, the nut may be threadedly engaged and moved along the threaded zone such that a null axial load is applied onto the bearing assemblies 160a and 16b, in which the nut abuts the bearing assembly 160a, but without necessarily applying an axial load onto the bearing assemblies 160a,160b and the sleeve 165. In another example, in this embodiment, the nut may be threadedly engaged and moved along the threaded zone such that a non-null axial load is applied onto the bearing assemblies 160a,16b and the sleeve 165, in which the nut abuts and presses on the bearing assembly 160a, thereby applying an axial load onto the bearing assemblies 160a, 160b and the sleeve 165.

The support wheel assembly 100 is then disposed within the frame 62, between the lateral frame portions 66a, 66b.

The support wheel assembly 100 is then connected to the frame 62. More precisely, a fastener is received through an aperture (not shown) defined on the lateral frame portion 66a of the frame 62, and is fastened to the axle end portion 142a. Similarly, another fastener is received through an aperture (not shown) defined on the lateral frame portion 66b of the frame 62, and is fastened to the axle end portion 142b, thereby fixing the axle 140 to the frame 62.

To remove the support wheel assembly 100 from the frame 62, the fasteners are unfastened, thereby allowing quick removal of the support wheel assembly 100.

Now describing the present technology in operation, when the sprocket wheel assembly 70 rotates, driven by the driving axle, the sprocket wheel assembly 70 engages with the lugs 202 to drive the endless track 200, and thus the track system 60a. When the endless track 200 is driven, the front and rear idler wheel assemblies 80, 82 and the support wheel assemblies 100, 101, 102, 103, which engage the inner surface 210 of the endless track 200, rotate. Because the axle 140 of the front and rear idler wheel assemblies 80, 82 and the support wheel assemblies 100, 101, 102, 103 are fixed to the frame 62, the wheels 120 of the front and rear idler wheel assemblies 80, 82 and the support wheel assemblies 100, 101, 102, 103 rotate relative to their respective axles 140.

The bearing assemblies 160a, 160b, by reducing friction between moving parts (i.e., between wheel 120 and axle 140), also reduce the level of noise, the level of vibration and the level of heat that are generated. This, in turn, can enhance ride quality of the compact track loader 50 and can enable the compact track loader 50 to be operated at higher top speeds.

As previously mentioned, the presence of laterally reinforcing members in conventional track systems can pose a limit to the operational top speed of its vehicle. According to the present technology, however, as the endless track 200 is made from an elastomeric material free of lateral reinforcing members, the endless track 200 is less likely to vibrate at higher speeds. Thus, the endless track 200 can also enhance ride quality and enable the compact track loader 50 to be operated at higher speeds.

Thus, the present technology can enable the compact track loader 50 to reach higher top speeds while maintaining and/or improving ride quality and durability of the track systems 60a, 60b. In some embodiments, the present technology could improve a top speed of the compact track loader 50 by a factor of 2, 1.9, 1.8, 1.7, 1.6 or 1.5.

The various components of the track systems 60a, 60b are made of conventional materials (e.g., metals and metal alloys in most cases, such as steel) via conventional manufacturing processes (e.g., casting, molding, etc.). The present technology does not require any specific materials nor methods of manufacture. The present technology merely requires that each component be suitable for the purpose for which it is intended and the use to which it is to be put. Any material(s) or method(s) of manufacture which produce such components may be used in the present technology.

Modifications and improvements to the above-described embodiments of the present technology may become apparent to those skilled in the art. The foregoing description is intended to be exemplary rather than limiting.

1. A wheel assembly for a track system of a light heavy-duty vehicle, the track system having a frame and an elastomeric endless track, the wheel assembly being removably connectable to the frame, the wheel assembly comprising:
a wheel defining a wheel cavity;
an axle receivable in the wheel cavity and including a first end portion, a middle portion, and a second end portion,
the axle defining a shoulder member proximate to the first end portion and a retaining zone proximate to the second end portion;
a first bearing assembly and a second bearing assembly, the first and second bearing assemblies rotationally connecting the axle to the wheel,
the first bearing assembly being disposed in the wheel cavity proximate to the first end portion and inwardly from the shoulder member; and
the second bearing assembly being disposed in the wheel cavity proximate to the second end portion and inwardly from the retaining zone;
a sleeve member being disposed on the middle portion and between the first bearing assembly and the second bearing assembly; and
a retaining member cooperating with the retaining zone such that the first and second bearing assemblies are prevented from axial movement by the shoulder member, the sleeve member, and the retaining member.

2. The wheel assembly of claim 1, wherein the wheel has a first side and a second side opposite to the first side, and a portion of the first end portion of the axle extends from the first side of the wheel and a portion of the second end portion of the axle extends from the second side of the wheel.

3. The wheel assembly of claim 1, further comprising:
a first seal disposed in the wheel cavity, outwardly to the first bearing assembly and in contact with the wheel and the axle, the first seal sealing one side of the wheel cavity; and
a second seal disposed in the wheel cavity, outwardly to the second bearing assembly and in contact with the wheel and the axle, the second seal sealing another side of the wheel cavity.

4. The wheel assembly of claim 1, wherein the first bearing assembly includes a first seal integrated to the first bearing assembly and the second bearing assembly includes a second seal integrated to the second bearing assembly.

5. The wheel assembly of claim 1, further comprising a first fastener connectable to the first end portion of the axle and a second fastener connectable to the second end portion of the axle, the first and second fasteners removably connecting the wheel assembly to the frame of the track system.

6. The wheel assembly of claim 1, wherein the first and second bearing assemblies are connected to the axle by one of an interference fit, a clearance fit, and a transition fit.

7. The wheel assembly of claim 1, wherein the retaining member is a nut and the retraining zone is a threaded zone configured to cooperate with the nut.

8. The wheel assembly of claim 1, wherein the wheel cavity has an inner cylindrical wall and the first and second bearing assemblies are connected to the inner cylindrical wall by one of an interference fit, a clearance fit, and a transition fit.

9. The wheel assembly of claim 1, wherein at least one of the first and the second bearing assemblies includes a spherical bearing.

10. The wheel assembly of claim 1, wherein at least one of the first and the second bearing assemblies includes a spherical roller bearing.

11. The wheel assembly of claim 1, wherein at least one of the first and the second bearing assemblies includes a tapered roller bearing.

12. The wheel assembly of claim 1, wherein the wheel has a first track-engaging portion, a second track-engaging portion, and a central portion defined between the first and second track engaging portions.

13. The wheel assembly of claim 1, wherein the elastomeric track is a polymeric elastomeric track.

14. The wheel assembly of claim 1, wherein the elastomeric track is laterally deformable.

15. The wheel assembly of claim 14, wherein the elastomeric track is laterally deformable along an entire width of the elastomeric track.

16. The wheel assembly of claim 1, wherein the elastomeric track is longitudinally reinforced.

17. The wheel assembly of claim 16, wherein the elastomeric track is longitudinally reinforced with longitudinal reinforcing members.

18. The wheel assembly of claim 16, wherein the longitudinally reinforced elastomeric track is non-reinforced laterally.

19. A track system operatively connectable to a light heavy-duty vehicle, the track system comprising the wheel assembly of claim 1.

20. A light heavy-duty vehicle comprising the track system of claim 19.
